(19) United States
(12) Patent Application Publication
(10) Pub. No.: US 2024/0193716 A1
(43) Pub. Date: Jun. 13, 2024

(54) PARKING SPACE ALLOCATION METHOD FOR VEHICLES HAVING DIFFERENT DRIVING MODES

(71) Applicant: NANCHANG AUTOMOTIVE INSTITUTE OF INTELLIGENCE AND NEW ENERGY.TONGJI UNIVERSITY, NANCHANG (CN)

(72) Inventors: DEQUAN ZENG, NANCHANG (CN); CHAGEN LUO, NANCHANG (CN); YIMING HU, NANCHANG (CN); DENGCHENG LIU, NANCHANG (CN); YISHUAI LI, NANCHANG (CN); QIPING CHEN, NANCHANG (CN)

(21) Appl. No.: 18/484,461

(22) Filed: Oct. 11, 2023

Related U.S. Application Data
(63) Continuation of application No. PCT/CN2022/141312, filed on Dec. 23, 2022.

(30) Foreign Application Priority Data
Dec. 9, 2022 (CN) 202211575967.3

(51) Int. Cl. G06Q 50/30; B60W 30/06; G08G 1/14

(52) U.S. Cl. CPC G06Q 50/30; B60W 30/06; G08G 1/145

(57) ABSTRACT

A parking space allocation method for vehicles having different driving modes includes steps of constructing single-vehicle cost models corresponding to driving modes of to-be-parked vehicles, respectively constructing single-vehicle parking difficulty cost models based on sizes of the to-be-parked vehicles and parking space types; constructing user walking cost models and user psychological cost models based on the driving modes of the to-be-parked vehicles and psychological cost coefficients of users; constructing parking space allocation cost models; constructing limiting conditions for the parking space allocation cost models to obtain parking allocation models; performing cost balancing and allocating on the parking allocation models based on a minimum cost condition, constructing optimization problems for the single-vehicle cost models, the single-vehicle parking difficulty cost models, the user walking cost models, the user psychological cost models, and the parking allocation models; and solving the optimization problems to obtain parking space allocation schemes.

### TECHNICAL FIELD

The present disclosure relates to a technical field of parking space allocations, and in particular to a parking space allocation method for vehicles having different driving modes.

### BACKGROUND

With advancement of technology, unmanned vehicles gradually penetrates into people's daily lives. These emerging automotive products are still in an infancy. Therefore, there are manned vehicles, unmanned vehicles, and a mixture of manned and unmanned vehicles in current parking lots.

Since the unmanned vehicle parking technology is expected to effectively solve increasingly severe parking problems, unmanned vehicle parking technology becomes a research focus and hot spot among major universities and enterprises. However, current research and products are still at a level of solving single-vehicle parking, and research and development of multi-vehicle parking is in a blank period. Since the multi-vehicle parking requires an coordination of resources to maximize macro-system benefits and minimize micro-individual costs, the multi-vehicle parking is more technically complex than single-vehicle parking, and the multi-vehicle parking is also a challenge that must be faced when deploying unmanned vehicle parking in the future.

In addition, in a mixed driving state of the manned vehicles and the unmanned vehicles, how to effectively realize coordinated driving of the manned vehicles and the unmanned vehicles is a prerequisite to ensure order and stability of a transportation system. Especially in a narrow parking lot, if a manned vehicle and an unmanned vehicle compete for a same parking space at the same time, traffic congestion and even serious traffic accidents such as collisions may inevitably occur.

### SUMMARY

In view of this, a purpose of the present disclosure is to provide a parking space allocation method for vehicles having different driving modes to solve defects in the prior art.

To achieve the above purpose, the present disclosure provides the parking space allocation method for vehicles having different driving modes. The parking space allocation method comprises:
respectively constructing single-vehicle cost models corresponding to driving modes of to-be-parked vehicles, and respectively constructing single-vehicle parking difficulty cost models based on sizes of the to-be-parked vehicles and parking space types;
respectively constructing user walking cost models and user psychological cost models based on the driving modes of the to-be-parked vehicles and psychological cost coefficients of users; respectively constructing parking space allocation cost models based on the driving modes of the to-be-parked vehicles, and constructing limiting conditions for the parking space allocation cost models to obtain parking allocation models;
performing cost balancing and allocating on the parking allocation models based on a minimum cost condition, and constructing optimization problems for the single-vehicle cost models, the single-vehicle parking difficulty cost models, the user walking cost models, the user psychological cost models, and the parking allocation models; and
solving the optimization problems to obtain parking space allocation schemes according to the tabu search algorithm and the ant colony algorithm.

Furthermore, the driving modes comprise a manned driving mode and an unmanned driving mode. A step of respectively constructing the single-vehicle cost models corresponding to the driving modes of the to-be-parked vehicles comprises:
constructing a first single-vehicle parking distance cost model when a to-be-parked vehicle i in the manned driving mode is allocated to a parking space j according to a parking distance thereof, and
constructing a second single-vehicle parking distance cost model or a first single-vehicle parking time cost model when a to-be-parked vehicle k in the unmanned driving mode is allocated to the parking space j according to a parking distance thereof and a parking time thereof.

Furthermore, an expression of the first single-vehicle parking distance cost model is:

$${r}_{i , j}^{D} = {\sum }_{s = 1}^{S} ( {a}_{s}^{drive} \frac{{l}_{s}}{{v}_{s}} + {a}_{s}^{block} {r}_{s}^{block} + {a}_{s}^{turn} {r}_{s}^{turn} )$$

S is a total number of road sections that the to-be-parked vehicle i in the manned driving mode needs to pass to get to the parking space j. aₛ^{drive} is a parking distance cost coefficient. 1ₛ is a mileage of an S^{th} road section. vₛ is an allowable speed of a parking lot. aₛ^{block} is a cost coefficient affected by parking of a vehicle ahead. rₛ^{block} is an additional cost affected by the parking of the vehicle ahead. A value of rₛ^{block} is a blocking time affected by the parking of the vehicle ahead. aₛ^{turn} is a cost coefficient affected by a curve on the S^{th} road section. rₛ^{turn} is an additional cost affected by the curve.

An expression of the second single-vehicle parking distance cost model is:

$${r}_{k , j}^{D} = {\sum }_{s = 1}^{S} ( {a}_{s}^{drive} \frac{{l}_{s}}{{v}_{s}} + {a}_{s}^{block} {r}_{s}^{block} + {a}_{s}^{turn} {r}_{s}^{turn} )$$

When the to-be-parked vehicle i in the manned driving mode or the to-be-parked vehicle k in the unmanned driving mode passes through the S^{th} road section, if there are parking vehicles on the S^{th} road section, the cost coefficient aₛ^{block} affected by the parking of the vehicle ahead is 1, and if there are no parking vehicles on the S^{th} road section, the cost coefficient aₛ^{block} affected by the parking of the vehicle ahead is 0.

Furthermore, an expression of the first single-vehicle parking time cost model is:

$${c}_{k , j}^{min D} = \frac{{t}_{k}^{a}}{nm} + ( {t}_{k , j}^{s} + {t}_{k , j}^{b} + {t}_{k , j}^{t} ) {x}_{k , j} .$$

k is a serial number of the to-be-parked vehicle k in the unmanned driving mode. The smaller a val101ue of k, the earlier the to-be-parked vehicle k in the unmanned driving mode arrives at the parking lot. n is a total number of to-be-parked vehicles in the unmanned driving mode. m is a total number of available parking spaces in the parking lot. tₖ^{a} is a time cost for the to-be-parked vehicle k in the unmanned driving mode to arrive at the parking lot. t_{k,j}^{s} is a driving time cost converted from a distance from the to-be-parked vehicle k in the unmanned driving mode to the parking space j. t_{i,j}^{b} is a blocking waiting time cost from the to-be-parked vehicle k in the unmanned driving mode to the parking space j. t_{i,j}^{t} is an additional time cost affected by the curve from the to-be-parked vehicle k in the unmanned driving mode to the parking space j. x_{k,j}={0, 1} is a Boolean variable. When x_{k,j}=0, the to-be-parked vehicle k in the unmanned driving mode is not allocated to the parking space j. When x_{k,j}=1, the to-be-parked vehicle k in the unmanned driving mode is allocated to the parking space j.

Furthermore, a step of respectively constructing the single-vehicle parking difficulty cost models based on sizes of the to-be-parked vehicles and parking space types comprises respectively constructing a first single-vehicle parking difficulty cost model and a second single-vehicle parking difficulty cost model according to the sizes of the to-be-parked vehicles and the parking space types.

An expression of the first single-vehicle parking difficulty cost model is

r_{i,j}^{P}=(a_{i,j}^{len}+aⱼ^{lot})rₚ;

r_{k,j}^{P}=(a_{k,j}^{len}+aⱼ^{lot})rₚ;

a_{i,j}^{len} is a cost coefficient affected by a length of the to-be-parked vehicle i in the manned driving mode. aⱼ^{lot} is a cost coefficient affected by a parking characteristics of the parking space j. rₚ is a conventional parking cost. a_{k,j}^{len} is a cost coefficient affected by the to-be-parked vehicle k in the unmanned driving mode. A calculation formula of the cost coefficient aⱼ^{lot} affected by the length of the to-be-parked vehicle i in the manned driving mode is:

$${a}_{i , j}^{len} = \frac{{l}_{i}^{car}}{{l}_{j}^{lot}} .$$

lᵢ^{car} is the length of the to-be-parked vehicle i in the manned driving mode. lⱼ^{lot} is a length of the parking space j. A calculation formula of the cost coefficient a_{i,j}^{len} affected by the to-be-parked vehicle k in the unmanned driving mode is:

$${a}_{k , j}^{len} = \frac{{l}_{k}^{car}}{{l}_{j}^{lot}} .$$

lₖ^{car} is a length of the to-be-parked vehicle k in the unmanned driving mode. An expression of the second vehicle parking difficulty cost model is:

c_{k,j}^{minp}+(a_{k,j}^{len}+aⱼ^{lot})tₚx_{k,j}.

Tₚ is a conventional parking cost.

Furthermore, in a step of respectively constructing user walking cost models and user psychological cost models based on the driving modes of the to-be-parked vehicles and psychological cost coefficients of users, an expression of a user walking cost model for the to-be-parked vehicle i in the manned driving mode is:

r_{i,j}^{W}=aᵢ^{lot}r_{i,j}^{lot}+aᵢ^{road}rᵢ^{road}.

aᵢ^{lot} is a walking cost coefficient for a user of the to-be-parked vehicle i in the manned driving mode to walk out the parking lot. r_{i,j}^{lot} is a walking cost for the user of the to-be-parked vehicle i in the manned driving mode to walk out the parking lot from the parking space j. A value of the walking cost for the user of the to-be-parked vehicle i in the manned driving mode to walk out the parking lot from the parking space j is a walking time of the user of the to-be-parked vehicle i in the manned driving mode to walk out the parking lot from the parking space j. aᵢ^{road} is a walking cost coefficient for the user of the to-be-parked vehicle i in the manned driving mode to walk to a destination from an outside of the parking lot. rᵢ^{road} is a walking cost for the user of the to-be-parked vehicle i in the manned driving mode to walk to the destination from the outside of the parking lot. The walking cost for the user of the to-be-parked vehicle i in the manned driving mode to walk to the destination from the outside of the parking lot is a walking time for the user of the to-be-parked vehicle i in the manned driving mode to walk to the destination from the outside of the parking lot.

An expression of a user psychological cost model of the user psychological cost models is r_{i,j}^{H}=a_{i,j}^{lot}aᵢ^{lot}r_{i,j}^{lot}+aᵢ^{road}aᵢ^{road}rᵢ^{road}.

a_{i,j}^{lot} is a psychological cost coefficient for the user of the to-be-parked vehicle i in the manned driving mode to walk out of the parking lot from the parking space j. aᵢ^{road} is a psychological cost coefficient for the user of the to-be-parked vehicle i in the manned driving mode to walk to the destination from the outside of the parking lot. an expression of the psychological cost coefficient a_{i,j}^{lot} for the user of the to-be-parked vehicle i in the manned driving mode to leave the parking lot from the parking space j is:

$${α}_{i , j}^{lot} = {α}_{lot} tanh ( \frac{{r}_{i , j}^{lot}}{{r}_{max}^{lot}} )$$

aₗₒₜ≥1.0. aₗₒₜ is an adjustment coefficient. rₘₐₓ^{lot} is a maximum walking cost acceptable to the user of the to-be-parked vehicle i in the manned driving mode for walking out of the parking lot from the parking space j.

An expression of the psychological cost coefficient for the user of the to-be-parked vehicle i in the manned driving mode to walk to the destination from the outside of the parking lot is:

$${α}_{i , j}^{road} = {α}_{road} tanh ( \frac{{r}_{i , j}^{road}}{{r}_{max}^{road}} ) ;$$

a_{road}≥1.0. a_{road} is an adjustment coefficient. rₘₐₓ^{road} is a maximum walking cost acceptable to the user of the to-be-parked vehicle i in the manned driving mode for walking to the destination from the outside of the parking lot.

Furthermore, an expression of the parking space allocation cost models is:

Rⱼ=Σᵢ₌₁^{l}r_{i,j}x_{i,j}+Σₖ₌₁^{K}r_{k,j}x_{k,j}.

r_{i,j}, is a single-vehicle parking space allocation cost of the to-be-parked vehicle i in the manned driving mode. r_{k,j}, is a single-vehicle parking space allocation cost of the to-be-parked vehicle k in the unmanned driving mode. I is a total number of the to-be-parked vehicles in the manned driving mode. K is a total number of the to-be-parked vehicle k in the unmanned driving mode. x_{i,j}={0, 1}. x_{i,j} is a binary variable. When x_{i,j}=0, the parking space j is not allocated to the to-be-parked vehicle i in the manned driving mode. When x_{i,j}=1, the parking space j is allocated to the to-be-parked vehicle i in the manned driving mode. xₖ={0, 1}. xₖ is a binary variable. When xₖ,=0, the parking space j is not allocated to the to-be-parked vehicle k in the unmanned driving mode. When xₖ,=1, the parking space j is allocated to the to-be-parked vehicle k in the unmanned driving mode.

For the parking space j allocated to the to-be-parked vehicle i in the manned driving mode, an expression of a single-vehicle parking space allocation cost model thereof is r_{i,j}=r_{i,j}^{D}+r_{i,j}^{P}+r_{i,j}^{W}+r_{i,j}^{H}.

For the parking space j allocated to the to-be-parked vehicle k in the unmanned driving mode, an expression of a single-vehicle parking space allocation cost model thereof is r_{k,j}=r_{k,j}^{D}+r_{k,j}^{P}+r_{k,j}^{W}+r_{k,j}^{H}.

Furthermore, in a step of performing cost balancing and allocating on the parking allocation models based on the minimum cost condition, when the parking space j is allocated to the to-be-parked vehicle k in the unmanned driving mode, an expression of a single-vehicle parking space allocation cost model having a minimum cost is:

c_{k,j}^{min}=c_{k,j}^{minD}+c_{k,j}^{minP}.

For the to-be-parked vehicle k in the unmanned driving mode, an expression of a single-vehicle parking space allocation total cost model having the minimum cost is:

cₖ^{min}=Eₕ₌₁^{m}c_{k,j}^{min}=Σₕ₌₁^{m}(c_{k,j}^{minD}+c_{k,j}^{minP}).

A parking space allocation total cost model having a minimum cost is obtained base on the single-vehicle parking space allocation cost model having the minimum cost and the single-vehicle parking space allocation total cost model having the minimum cost, an expression thereof is:

c^{min}=Σₖ₌₁ⁿcₖ^{min}=Σₖ₌₁ⁿΣⱼ₌₁^{m}c_{k,j}^{min}=Σₖ₌₁ⁿΣⱼ₌₁^{m}(c_{k,j}^{minD}+c_{k,j}^{minP}).

Furthermore, before a step of solving the optimization problems to obtain the parking space allocation schemes according to the tabu search algorithm and the ant colony algorithm, the parking space allocation method further comprises:
respectively constructing a first-come-first-served single-vehicle driving cost model, a first-come-first-served single-vehicle parking difficulty cost model, a first-come-first-served single-vehicle parking space allocation cost model, and a first-come-first-served single-vehicle parking space allocation total cost model based on a first-come-first-served allocation rule; and
constructing a first-come-first-served allocation optimization problem based on the first-come-first-served single-vehicle driving cost model, the first-come-first-served single-vehicle parking difficulty cost model, the first-come-first-served single-vehicle parking space allocation cost model, and the first-come-first-served single-vehicle parking space allocation total cost model.

Furthermore, the step of solving the optimization problems to obtain the parking space allocation scheme according to the tabu search algorithm and the ant colony algorithm comprises:
solving the optimization problems and the first-come-first-served allocation optimization problem according to the tabu search algorithm and the ant colony algorithm; and using an obtained optimal solution as a reference value of the parking space allocation scheme to construct the parking space allocation scheme.

In the parking space allocation method for vehicles having different driving modes, the single-vehicle cost models are respectively constructed based on the driving modes of to-be-parked vehicles, and the single-vehicle parking difficulty cost models are respectively constructed based on the sizes of the to-be-parked vehicles and the parking space types. Further, the user walking cost models, the psychological cost models, the parking space allocation total cost model having the minimum total cost, and the first-come-first-served parking space allocation model are used, while considering the driving cost, the unmanned driving mode, and manned driving mode, the parking difficult cost is also taken into account, which jointly vividly describes a parking space allocation problem of unmanned vehicles and a parking space allocation problem of mixed vehicles including the unmanned vehicles and the manned vehicles. Moreover, the parking space allocation problem of the mixed vehicles including the unmanned vehicles and the manned vehicles are solved based on the tabu search algorithm, so as to realize quick parking space allocation of the mixed vehicles including the unmanned vehicles and the manned vehicles. The parking space allocation problem of the unmanned vehicles is solved based on the ant colony algorithm, so as to realize quick parking space allocation of the unmanned vehicles.

### BRIEF DESCRIPTION OF DRAWINGS

FIG. 1 is a flow chart of a parking space allocation method for vehicles having different driving modes according to one embodiment of the present disclosure.

FIG. 2 is a flow chart of a step S101 shown in FIG. 1.

FIG. 3 is a schematic diagram of a parking space allocation scenario for mixed vehicles including vehicles in a manned driving mode and vehicles in an unmanned driving mode according to one embodiment of the present disclosure.

FIG. 4 is a schematic diagram of a parking space allocation scenario for the vehicles in the unmanned driving according to one embodiment of the present disclosure.

FIG. 5 is a schematic diagram of a first parking space type where two sides of a parking space is unoccupied according to one embodiment of the present disclosure.

FIG. 6 is a schematic diagram of a second parking space type where a vehicle is located on a first side of the parking space according to one embodiment of the present disclosure.

FIG. 7 is a schematic diagram of the parking space type where the vehicle is located on a second side of the parking space according to one embodiment of the present disclosure.

FIG. 8 is a schematic diagram of a third parking space type where a support object is disposed on the first side of the parking space according to one embodiment of the present disclosure.

FIG. 9 is a schematic diagram of the third parking space type where the support object is disposed on the second side of the parking space according to one embodiment of the present disclosure.

FIG. 10 is a schematic diagram of a fourth parking space type where two sides of the parking space are unoccupied by vehicles according to one embodiment of the present disclosure.

FIG. 11 is a schematic diagram of a fifth parking space type where support objects are disposed on two sides of the parking space according to one embodiment of the present disclosure.

The following specific embodiments further illustrate the present disclosure in conjunction with the above-mentioned drawings.

### DETAILED DESCRIPTION

In order to facilitate understanding of the present disclosure, the present disclosure will be described fully hereinafter with reference to the accompanying drawings. Several embodiments of the present disclosure are presented in the accompanying drawings. However, the present disclosure may be implemented in many different forms and is not limited to the embodiments described herein. Further, the purpose of providing these embodiments is to make the disclosure of the present disclosure thorough and comprehensive.

It should be noted that when an element is referred to as being “fixed to” another element, it may be directly fixed on another element or an intervening element may also be present. When an element is considered to be “connected” to another element, it may be directly connected to another element or an intervening element may also be present. The terms “vertical”, “horizontal”, “left”, “right”, and the like used herein are for illustrative purposes only.

Unless otherwise defined, all technical and scientific terms used herein have the same meaning as commonly understood by those skilled in the art of the present disclosure. The terms used in the description of the present disclosure herein are only for the purpose of describing specific embodiments, and are not intended to limit the present disclosure. The term “and/or” used in the present disclosure includes any and all combinations of one or more of the associated listed items.

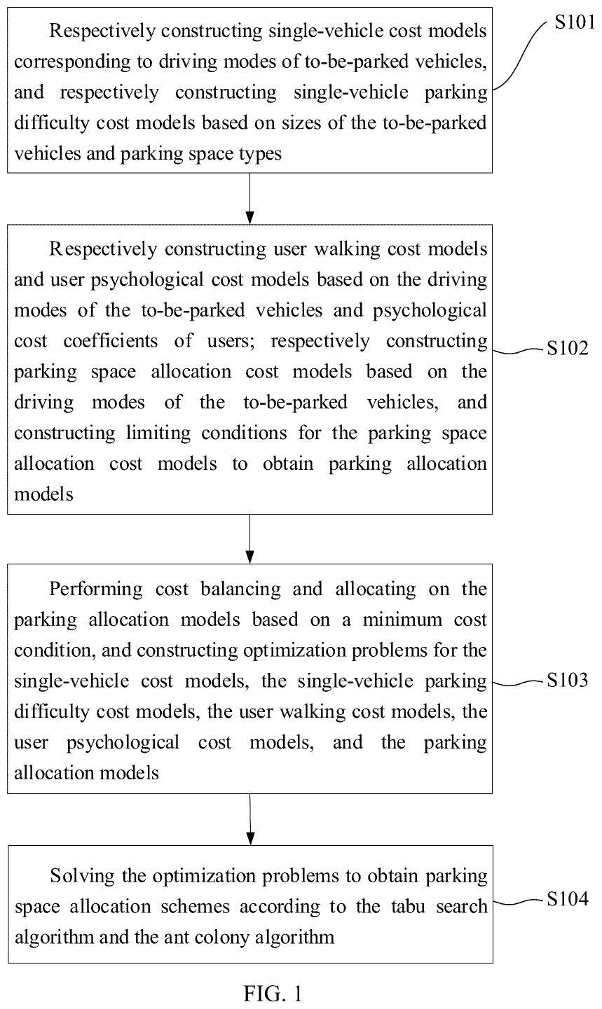

As shown in FIG. 1, FIG. 1 is a flow chart of a parking space allocation method for vehicles having different driving modes according to one embodiment of the present disclosure. The parking space allocation method for vehicles having different driving modes specifically comprises steps S101-S104.

S101: respectively constructing single-vehicle cost models corresponding to driving modes of to-be-parked vehicles, and respectively constructing single-vehicle parking difficulty cost models based on sizes of the to-be-parked vehicles and parking space types;

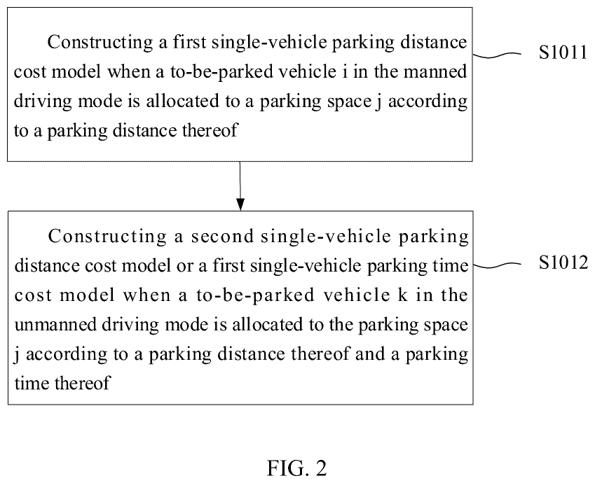

Furthermore, as shown in FIG. 2, the driving modes comprise a manned driving mode and an unmanned driving mode. The step S101 comprises steps S1011-S1012.

S1011: constructing a first single-vehicle parking distance cost model when a to-be-parked vehicle i in the manned driving mode is allocated to a parking space j according to a parking distance thereof, and

S1012: constructing a second single-vehicle parking distance cost model or a first single-vehicle parking time cost model when a to-be-parked vehicle k in the unmanned driving mode is allocated to the parking space j according to a parking distance thereof and a parking time thereof.

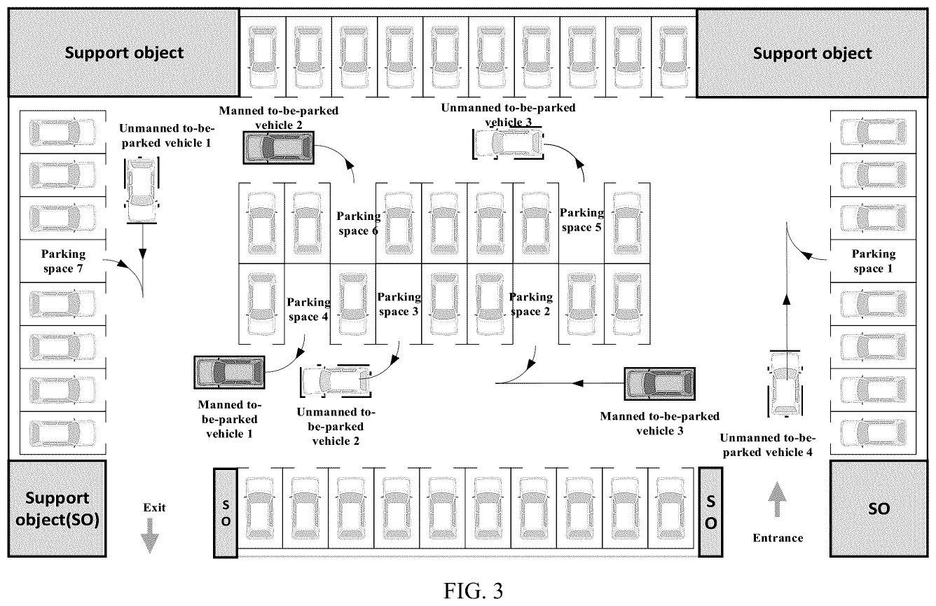

It should be noted that in the parking space allocation method of the present disclosure, the driving modes comprises the manned driving mode, the unmanned driving mode, and a mixed driving mode thereof. As shown in FIG. 3, FIG. 3 is a schematic diagram of a parking space allocation scenario for mixed vehicles including vehicles in the manned driving mode and vehicles in the unmanned driving mode according to one embodiment of the present disclosure.

For parking space allocation of the mixed vehicles including the vehicles in the manned driving mode and the vehicles in the unmanned driving mode, when the to-be-parked vehicle i in the manned driving mode is allocated to the parking space j, an expression of the first single-vehicle parking distance cost model is:

$${r}_{i , j}^{D} = {\sum }_{s = 1}^{S} ( {a}_{s}^{drive} \frac{{l}_{s}}{{v}_{s}} + {a}_{s}^{block} {r}_{s}^{block} + {a}_{s}^{turn} {r}_{s}^{turn} ) .$$

S is a total number of road sections that the to-be-parked vehicle i in the manned driving mode needs to pass to get to the parking space j. aₛ^{drive} is a parking distance cost coefficient. 1ₛ is a mileage of an S^{th} road section. vₛ is an allowable speed of a parking lot. aₛ^{block} is a cost coefficient affected by parking of a vehicle ahead. rₛ^{block} is an additional cost affected by the parking of the vehicle ahead. A value of rₛ^{block} is a blocking time affected by the parking of the vehicle ahead. aₛ^{turn} is a cost coefficient affected by a curve on the S^{th} road section. rₛ^{turn} is an additional cost affected by the curve.

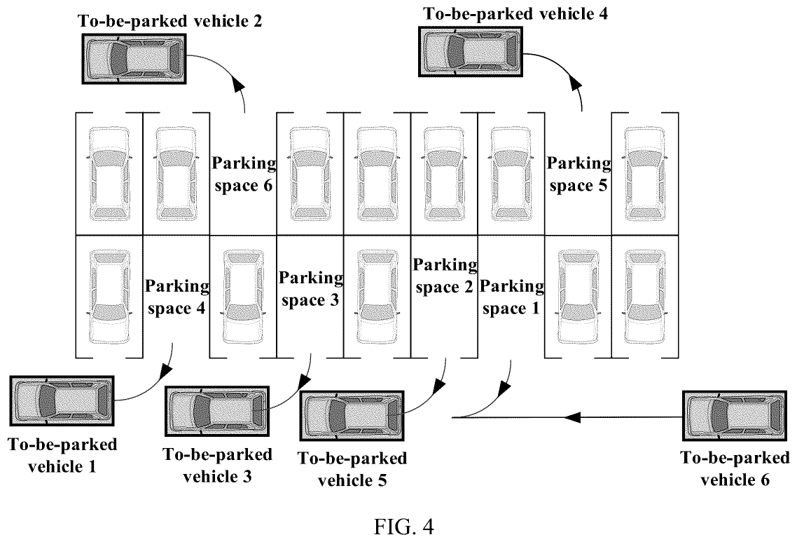

As shown in FIG. 4, for parking space allocation of the vehicles in the unmanned driving mode, when the to-be-parked vehicle k in the unmanned driving mode is allocated to the parking space j, an expression of the second single-vehicle parking distance cost model is:

$${r}_{k , j}^{D} = {\sum }_{s = 1}^{S} ( {a}_{s}^{drive} \frac{{l}_{s}}{{v}_{s}} + {a}_{s}^{block} {r}_{s}^{block} + {a}_{s}^{turn} {r}_{s}^{turn} ) .$$

When the to-be-parked vehicle i in the manned driving mode or the to-be-parked vehicle k in the unmanned driving mode passes through the S^{th} road section, if there are parking vehicles on the S^{th} road section, the cost coefficient aₛ^{block} affected by the parking of the vehicle ahead is 1, and if there are no parking vehicles on the S^{th} road section, the cost coefficient aₛ^{block} affected by the parking of the vehicle ahead is 0.

Furthermore, an expression of the first single-vehicle parking time cost model is:

$${c}_{k , j}^{min D} = \frac{{t}_{k}^{a}}{nm} + ( {t}_{k , j}^{s} + {t}_{k , j}^{b} + {t}_{k , j}^{t} ) {x}_{k , j} .$$

k is a serial number of the to-be-parked vehicle k in the unmanned driving mode. The smaller a value of k, the earlier the to-be-parked vehicle k in the unmanned driving mode arrives at the parking lot. n is a total number of to-be-parked vehicles in the unmanned driving mode. m is a total number of available parking spaces in the parking lot. tₖ^{a}is a time cost for the to-be-parked vehicle k in the unmanned driving mode to arrive at the parking lot. t_{k,j}^{s} is a driving time cost converted from a distance from the to-be-parked vehicle k in the unmanned driving mode to the parking space j. t_{k,j}^{b} is a blocking waiting time cost from the to-be-parked vehicle k in the unmanned driving mode to the parking space j. t_{k,j}^{t} is an additional time cost affected by the curve from the to-be-parked vehicle k in the unmanned driving mode to the parking space j. x_{k,j}={0, 1} is a Boolean variable. When x_{k,j}=0, the to-be-parked vehicle k in the unmanned driving mode is not allocated to the parking space j. When x_{k,j}=1, the to-be-parked vehicle k in the unmanned driving mode is allocated to the parking space j.

Specifically, in the manned driving mode or the mixed driving mode, a first single-vehicle parking difficulty cost model is constructed according to the sizes of the to-be-parked vehicles and the parking space types.

An expression of the first single-vehicle parking difficulty cost model is

r_{i,j}^{P}=(a_{i,j}^{len}+aⱼ^{lot})rₚ;

r_{k,j}^{P}=(a_{k,j}^{len}+aⱼ^{lot})rₚ.

a_{i,j}^{len} is a cost coefficient affected by a length of the to-be-parked vehicle i in the manned driving mode. aⱼ^{lot} is a cost coefficient affected by a parking characteristics of the parking space j. rₚ is a conventional parking cost. a_{k,j}^{len} is a cost coefficient affected by the to-be-parked vehicle k in the unmanned driving mode. A calculation formula of the cost coefficient a_{i,j}^{len} affected by the length of the to-be-parked vehicle i in the manned driving mode is:

$${a}_{i , j}^{len} = \frac{{l}_{i}^{car}}{{l}_{j}^{lot}} .$$

lᵢ^{car} is the length of the to-be-parked vehicle i in the manned driving mode. lⱼ^{lot} is a length of the parking space j. A calculation formula of the cost coefficient a_{k,j}^{len} affected by the to-be-parked vehicle k in the unmanned driving mode is:

$${a}_{k , j}^{l e n} = \frac{{l}_{k}^{c a r}}{{l}_{j}^{l o t}} .$$

lₖ^{car} is a length of the to-be-parked vehicle k in the unmanned driving mode.

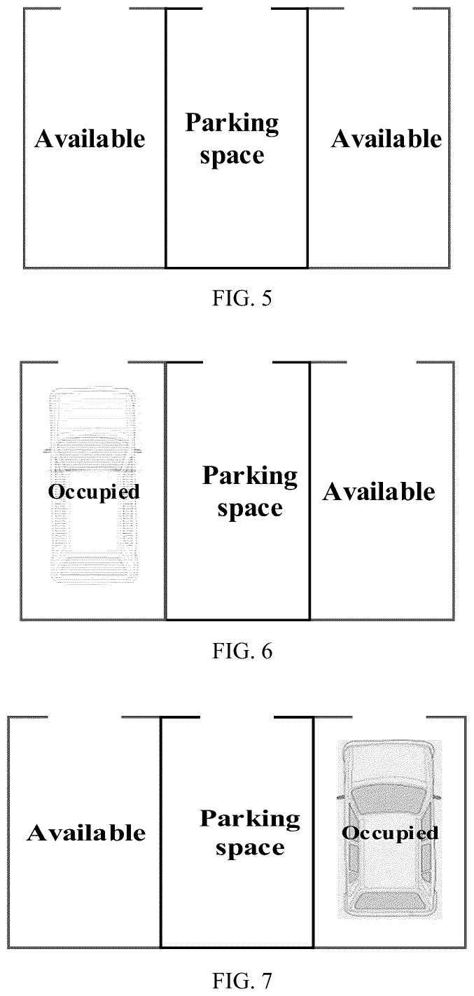

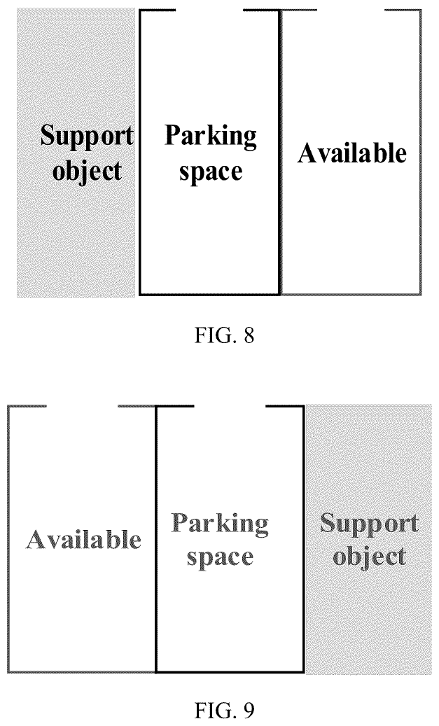

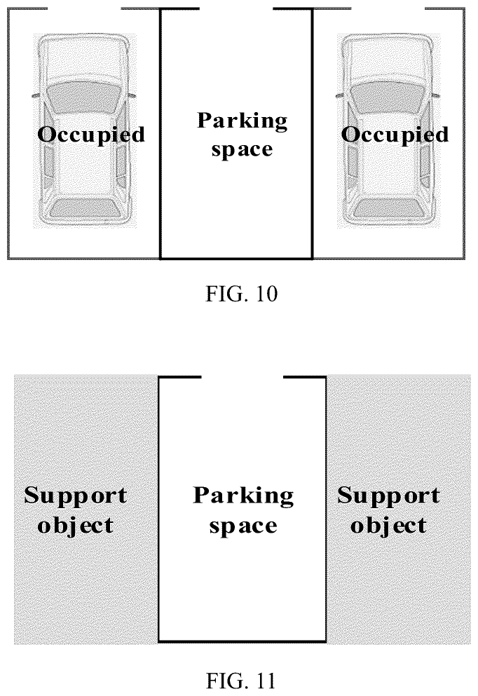

In the manned driving mode or in the mixed driving mode, the parking space types of the parking space j comprises a first parking space type where two sides of the parking space j are not occupied (as shown in FIG. 5), a second parking space type where a vehicle is located on one side of the parking space j (as shown in FIGS. 6 and 7), a third parking space type where a support object is disposed on one side of the parking space j (as shown in FIGS. 8 and 9), a fourth parking space type where vehicles are located on two sides of the parking space (as shown in FIG. 10), and a fifth parking space type where support objects are disposed on two sides of the parking space j (as shown in FIG. 10). Difficulty cost coefficients aⱼ^{lot} of the above five parking space types of the parking space j increase in sequence. In the embodiment, the difficulty cost coefficients aⱼ^{lot} are respectively set to 0.8, 0.9, 1.0, 1.1, and 1.2.

Furthermore, in the unmanned driving mode, a second single-vehicle parking difficulty cost model is constructed according to the sizes of the to-be-parked vehicles and the parking space types.

An expression of the second single-vehicle parking difficulty cost model is

c_{k,j}^{minP}=(a_{k,j}^{len}+aⱼ^{lot})tₚx_{k,j};

Tₚ is a conventional parking cost.

In the unmanned driving mode, the parking space types of the parking space j comprises a first parking space type where two sides of the parking space j are not occupied (as shown in FIG. 5), a second parking space type where one side of the parking space j is occupied (as shown in FIGS. 6-9), a third parking space type where two sides of the parking space are occupied (as shown in FIGS. 10-11). Difficulty cost coefficients aⱼ of the above three parking space types of the parking space j increase in sequence. In the embodiment, the difficulty cost coefficients a_{j are} respectively set to 1.0, 1.1, and 1.2.

S102: respectively constructing user walking cost models and user psychological cost models based on the driving modes of the to-be-parked vehicles and psychological cost coefficients of users; respectively constructing parking space allocation cost models based on the driving modes of the to-be-parked vehicles, and constructing limiting conditions for the parking space allocation cost models to obtain parking allocation models;

In an actual implementation, when the to-be-parked vehicle i is in the manned driving mode, a user needs to leave the parking lot on foot and go to a destination after parking the to-be-parked vehicle i in the parking space. Therefore, in the manned driving mode and the mixed driving mode, an expression of a user walking cost model for the to-be-parked vehicle i in the manned driving mode is:

r_{i,j}^{W}=aᵢ^{lot}r_{i,j}^{lot}+aᵢ^{road}rᵢ^{road}.

aᵢ^{lot} is a walking cost coefficient for a user of the to-be-parked vehicle i in the manned driving mode to walk out the parking lot. r_{i,j}^{lot} is a walking cost for the user of the to-be-parked vehicle i in the manned driving mode to walk out the parking lot from the parking space j. A value of the walking cost for the user of the to-be-parked vehicle i in the manned driving mode to walk out the parking lot from the parking space j is a walking time of the user of the to-be-parked vehicle i in the manned driving mode to walk out the parking lot from the parking space j. aᵢ^{road} is a walking cost coefficient for the user of the to-be-parked vehicle i in the manned driving mode to walk to a destination from an outside of the parking lot. rᵢ^{road} is a walking cost for the user of the to-be-parked vehicle i in the manned driving mode to walk to the destination from the outside of the parking lot. The walking cost for the user of the to-be-parked vehicle i in the manned driving mode to walk to the destination from the outside of the parking lot is a walking time for the user of the to-be-parked vehicle i in the manned driving mode to walk to the destination from the outside of the parking lot.

In the unmanned driving mode, the user may get off the to-be-parked vehicle k at the destination and the to-be-parked vehicle k in the unmanned driving mode is automatically parked in the parking space. Therefore, a user walking cost model for the user of the to-be-parked vehicle k in the unmanned driving mode is r_{k,j}^{W}=0.

Furthermore, an expression of a user psychological cost model of the user psychological cost models is r_{i,j}^{H}=a_{i,j}^{lot}aᵢ^{lot}r_{i,j}^{lot}+aᵢ^{road}aᵢ^{road}rᵢ^{road}.

a_{i,j}^{lot} a psychological cost coefficient for the user of the to-be-parked vehicle i in the manned driving mode to walk out of the parking lot from the parking space j. aᵢ^{road} is a psychological cost coefficient for the user of the to-be-parked vehicle i in the manned driving mode to walk to the destination from the outside of the parking lot. An expression of the psychological cost coefficient a_{i,j}^{lot} for the user of the to-be-parked vehicle i in the manned driving mode to leave the parking lot from the parking space j is:

$${a}_{i , j}^{lot} = {a}_{lot} tanh ( \frac{{r}_{i , j}^{l o t}}{{r}_{max}^{l o t}} ) .$$

aₗₒₜ≥1.0. aₗₒₜ is an adjustment coefficient. r_{i,j}^{lot} is a maximum walking cost acceptable to the user of the to-be-parked vehicle i in the manned driving mode for walking out of the parking lot from the parking space j.

An expression of the psychological cost coefficient for the user of the to-be-parked vehicle i in the manned driving mode to walk to the destination from the outside of the parking lot is

$${a}_{i , j}^{road} = {a}_{road} tanh ( \frac{{r}_{i , j}^{r o a d}}{{r}_{max}^{r o a d}} ) .$$

a_{road}≥1.0. a_{road} is an adjustment coefficient. rₘₐₓ^{road} is a maximum walking cost acceptable to the user of the to-be-parked vehicle i in the manned driving mode for walking to the destination from the outside of the parking lot.

Similarly, in the unmanned driving mode, the user may get off the to-be-parked vehicle k at the destination and the to-be-parked vehicle k in the unmanned driving mode is automatically parked in the parking space. Therefore, a psychological cost model for the use of the to-be-parked vehicle k in the unmanned driving mode is

r_{k,j}^{H}=0.

Furthermore, in the manned driving mode and the mixed driving mode, an expression of the parking space allocation cost models is:

Rⱼ=Σᵢ₌₁^{I}r_{i,j}x_{i,j}+Σₖ₌₁^{K}r_{k,j}x_{k,j}.

r_{i,j} is a single-vehicle parking space allocation cost of the to-be-parked vehicle i in the manned driving mode. r_{k,j} is a single-vehicle parking space allocation cost of the to-be-parked vehicle k in the unmanned driving mode. I is a total number of the to-be-parked vehicles in the manned driving mode. K is a total number of the to-be-parked vehicle k in the unmanned driving mode. x_{i,j}={0, 1}. x_{i,j} is a binary variable; when x_{i,j}=0, the paring space j is not allocated to the to-be-parked vehicle i in the manned driving mode. When x_{i,j}=1, the parking space j is allocated to the to-be-parked vehicle i in the manned driving mode. xₖ={0, 1}. xₖ is a binary variable. When xₖ,=0, the parking space j is not allocated to the to-be-parked vehicle k in the unmanned driving mode. When xₖ,=1, the parking space j is allocated to the to-be-parked vehicle k in the unmanned driving mode.

For the parking space j allocated to the to-be-parked vehicle i in the manned driving mode, an expression of a single-vehicle parking space allocation cost model thereof is r_{i,j}=r_{i,j}^{D}+r_{i,j}^{P}+r_{i,j}^{W}+r_{i,j}^{H}.

For the parking space j allocated to the to-be-parked vehicle k in the unmanned driving mode, an expression of a single-vehicle parking space allocation cost model thereof is r_{i,j}=r_{i,j}^{D}+r_{i,j}^{P}+r_{i,j}^{W}+r_{i,j}^{H}.

Specifically, in the manned driving mode and the mixed driving mode, a vehicle parking space allocation system total cost model is R=Σⱼ₌₁^{m}Rⱼ. m is the number of the parking spaces in the parking lot.

In the manned driving mode and the mixed driving mode, the vehicle parking space allocation system total cost model is constructed based on parking space allocation restrictions of the to-be-parked vehicles. Considering that one parking space is allowed to be allocated to at most one to-be-parked vehicle, and a parking space allocation restriction in the manned driving node and the mixed driving mode is Σᵢ₌₁^{I}x_{i,j}+Σₖ₌₁^{K}x_{k,j}≤1,Σᵢ₌₁^{I}x_{i,j}≤1, and Σₖ₌₁^{K}x_{k,j}≤1. Considering that one to-be-parked vehicle only occupies one parking space, a parking space allocation restriction in the mixed driving mode is Σⱼ₌₁^{m}x_{i,j}≤1 and Σⱼ₌₁^{m}x_{k,j}≤1.

Considering that one parking space is allowed to be allocated to at most one to-be-parked vehicle and one to-be-parked vehicle only occupies one parking space, a parking space allocation restriction for the to-be-parked vehicles in the manned driving node and the mixed driving mode is Σⱼ₌₁^{m}Σᵢ₌₁^{I}x_{i,j}≤min(I,m), Σⱼ₌₁^{m}Σₖ₌₁^{K}x_{k,j}≤min(K,m), and Σⱼ₌₁^{m}(Σᵢ₌₁^{I}x_{i,j}+Σₖ₌₁^{K}x_{k,j})≤min(m,I+K).

S103: performing cost balancing and allocating on the parking allocation models based on a minimum cost condition, and constructing optimization problems for the single-vehicle cost models, the single-vehicle parking difficulty cost models, the user walking cost models, the user psychological cost models, and the parking allocation models; and

In the actual implementation, according to the above step S102, the parking allocation models for the to-be-parked vehicles in the manned driving mode and the mixed driving modes takes a minimum parking space allocation system total cost R as an objective function. At the same time, the parking space allocation restriction for the to-be-parked vehicles in the manned driving node and the mixed driving mode in the above step S102 is a constraint to construct a first one of the optimization problems. The first one of the optimization problems is shown in formula (1).

$$\begin{matrix}\begin{matrix}min \\ s . t .\end{matrix} {\sum }_{i = 1}^{I} {x}_{i , j} + {{\sum }^{R}}_{k = 1}^{K} {x}_{k , j} \leq 1 \\ {\sum }_{i = 1}^{I} {x}_{i , j} \leq 1 \\ {\sum }_{k = 1}^{K} {x}_{k , j} \leq 1 \\ {\sum }_{j = 1}^{m} {x}_{i , j} \leq 1 \\ {\sum }_{j = 1}^{m} {x}_{k , j} \leq 1 \\ {\sum }_{j = 1}^{m} {\sum }_{i = 1}^{I} {x}_{i , j} \leq min ( I , m ) \\ {\sum }_{j = 1}^{m} {\sum }_{k = 1}^{K} {x}_{k , j} \leq min ( K , m ) \\ {\sum }_{j = 1}^{m} ( {\sum }_{i = 1}^{I} {x}_{i , j} + {\sum }_{k = 1}^{K} {x}_{k , j} ) \leq min ( m , I + K )\end{matrix} \qquad ( 1 )$$

In the unmanned driving mode, when the parking space j is allocated to the to-be-parked vehicle k in the unmanned driving mode, an expression of a single-vehicle parking space allocation cost model having a minimum cost is:

c_{k,j}^{min}=c_{k,j}^{minD}+c_{k,j}^{minp}.

For the to-be-parked vehicle k in the unmanned driving mode, an expression of a single-vehicle parking space allocation total cost model having the minimum cost is:

cₖ^{min}=Σⱼ₌₁^{m}c_{k,j}^{min}=Σⱼ₌₁^{m}(c_{k,j}^{minD}+c_{k,j}^{minp}).

A parking space allocation total cost model having a minimum cost is obtained base on the single-vehicle parking space allocation cost model having the minimum cost and the single-vehicle parking space allocation total cost model having the minimum cost, an expression thereof is:

c^{min}=Σₖ₌₁ⁿcₖ^{min}=Σₖ₌₁^{m}c_{k,j}^{min}=Σₖ₌₁ⁿΣⱼ₌₁^{m}(c_{k,j}^{minD}+c_{k,j}^{minp}).

Specifically, in the unmanned driving mode, considering that one parking space is only allowed to be allocated to at most one to-be-parked vehicle, the parking space allocation constraint having the minimum total system cost is: Σₖ₌₁ⁿx_{k,j}≤1. Considering that one to-be-parked vehicle only occupies one parking space, the parking space allocation constraint having the minimum total system cost is: Σⱼ₌₁^{m}x_{k,j}≤1. Considering that a total number of available parking spaces in the parking lot is limited, the parking space allocation constraint having the minimum total system cost is Σₖ₌₁ⁿΣⱼ₌₁^{m}x_{k,j}≤min(n,m).

In the actual implementation, the parking space allocation model of the to-be-parked vehicle in the unmanned driving mode having the minimum total system cost takes a parking space allocation total cost c^{min} having the minimum total system cost as an objective function. At the same time, the parking space allocation restriction for the to-be-parked vehicles in the manned driving node and the mixed driving mode in the above step S102 is taken as the constraint to construct a second one of the optimization problems. The second one of the optimization problems is shown in formula (2):

$$\begin{matrix}\begin{matrix}min \\ s . t .\end{matrix} {c}^{min} \\ {\sum }_{k = 1}^{n} {x}_{k , j} \leq 1 \\ {\sum }_{j = 1}^{m} {x}_{k , j} \leq 1 \\ {\sum }_{k = 1}^{n} {\sum }_{j = 1}^{m} {x}_{k , j} \leq min ( n , m )\end{matrix} \qquad ( 2 )$$

Furthermore, a first-come-first-served single-vehicle driving cost model, a first-come-first-served single-vehicle parking difficulty cost model, a first-come-first-served single-vehicle parking space allocation cost model, and a first-come-first-served single-vehicle parking space allocation total cost model are respectively constructed based on a first-come-first-served allocation rule.

A first-come-first-served allocation optimization problem is constructed based on the first-come-first-served single-vehicle driving cost model, the first-come-first-served single-vehicle parking difficulty cost model, the first-come-first-served single-vehicle parking space allocation cost model, and the first-come-first-served single-vehicle parking space allocation total cost model.

In the actual implementation, the to-be-parked vehicle in the unmanned driving mode is allocated based on the first-come—first-served rule. Therefore, when the to-be-parked vehicle k in the unmanned driving mode is allocated to the parking space j, the first-come-first-served single-vehicle driving cost model is

$${c}_{k , j}^{firstD} = \frac{{t}_{k}^{a}}{n m} + ( {t}_{k , j}^{s} + {t}_{k , j}^{b} + {t}_{k , j}^{t} ) {y}_{k , j} . {y}_{kj} = \{ 0 , 1 \} .$$

γ_{k,j} is a Boolean variable. When γ_{k,j}=0, it means that the to-be-parked vehicle k in the unmanned driving mode is not allocated to the parking space j. On the contrary, when γ_{k,j}=1, it means that the to-be-parked vehicle k in the unmanned driving mode is allocated to the parking space. j.

According to the parking space types of the parking space j and a size of the to-be-parked vehicle k in the unmanned driving model, the first-come-first-served single-vehicle parking difficulty cost model is c_{k,j}^{firstP}=(aⱼ+b_{k,j})tₚγ_{k,j}. When the to-be-parked vehicle k in the unmanned driving mode is allocated to the parking space. J, the first-come-first-served single-vehicle parking space allocation cost model is c_{k,j}^{first}=c_{k,j}^{firstD}+c_{k,j}^{firstP}. For the to-be-parked vehicle k in the unmanned driving mode, the first-come-first-served single-vehicle parking space allocation total cost model is cₖ^{first}=Σⱼ₌₁^{m}c_{k,j}^{firstD}=Σⱼ₌₁^{m}(c_{k,j}^{firstD}+c_{k,j}^{firstP}).

Specifically, in the unmanned driving mode, considering that one parking space is only allowed to be allocated to at most one to-be-parked vehicle, a first-come-first-served parking space allocation constraint is Σₖ₌₁ⁿγ_{k,j}≤1. Considering that one to-be-parked vehicle only occupies one parking space, the first-come-first-served parking space allocation constraint is: Σⱼ₌₁^{m}γ_{k,j}≤1. Considering that the total number of available parking spaces in the parking lot is limited, the first-come-first-served parking space allocation constraint is Σₖ₌₁ⁿΣⱼ₌₁^{m}γ_{k,j}≤min(n,m).

Furthermore, a model of the first-come-first-served parking space allocation problem takes the first-come-first-served parking space allocation as the objective function. At the same time, above-mentioned first-come-first-served limiting conditions under the unmanned driving mode are used as constraints to construct a third one of the optimization problems. The third one of the optimization problems is shown in formula (3)

$$\begin{matrix}\begin{matrix}min \\ s . t .\end{matrix} \{ \begin{matrix}{c}_{1}^{first} \\ {c}_{2}^{first} \\ ⋮ \\ {c}_{n}^{first}\end{matrix} \\ {\sum }_{i = 1}^{n} {y}_{k , j} \leq 1 \\ {\sum }_{j = 1}^{m} {y}_{k , j} \leq 1 \\ {\sum }_{k = 1}^{n} {\sum }_{j = 1}^{m} {y}_{k , j} \leq min ( n , m )\end{matrix} \qquad ( 3 )$$

S104: solving the optimization problems to obtain parking space allocation schemes according to the tabu search algorithm and the ant colony algorithm.

After obtaining the above optimization problems, an adaptation value function of a vehicle parking space allocation problem under the manned driving mode and the mixed driving mode is designed. The adaptation value function J of the vehicle parking space allocation problem is designed as

$$J = \frac{1}{R} .$$

The vehicle parking space allocation problem is solved by the tabu search algorithm, so as to solve the vehicle parking space allocation problem of the to-be-parked vehicles in the manned driving mode and the mixed driving mode, thus obtaining the parking space allocation scheme thereof.

For the to-be-parked vehicles in the unmanned driving mode, the second one of the optimization problems (2) and the third one of the optimization problems (3) are solved by the ant colony algorithm to obtain optimal solutions, which are respectively {cₖ^{min*}}_{i∈n} and {cₖ^{first*}}_{i∈n}. The minimum total system cost is used as a target cost and a balanced allocation is performed on the target cost to obtain a final cost of each of the to-be-parked vehicles {cₖ^{min*}−cₖ^{first*}}_{i∈n}. so as to solve the vehicle parking space allocation problem of the to-be-parked vehicles in the unmanned driving mode and obtain the parking space allocation scheme thereof.

To sum up, in the above embodiments of the parking space allocation method for vehicles having different driving modes of the present disclosure, the single-vehicle cost models are respectively constructed based on the driving modes of to-be-parked vehicles, and the single-vehicle parking difficulty cost models are respectively constructed based on the sizes of the to-be-parked vehicles and the parking space types. Further, the user walking cost models, the psychological cost models, the parking space allocation total cost model having the minimum total cost, and the first-come-first-served parking space allocation model are used, while considering the driving cost, the unmanned driving mode, and manned driving mode, the parking difficult cost is also taken into account, which jointly vividly describes a parking space allocation problem of unmanned vehicles and a parking space allocation problem of mixed vehicles including the unmanned vehicles and the manned vehicles. Moreover, the parking space allocation problem of the mixed vehicles including the unmanned vehicles and the manned vehicles are solved based on the tabu search algorithm, so as to realize quick parking space allocation of the mixed vehicles including the unmanned vehicles and the manned vehicles. The parking space allocation problem of the unmanned vehicles is solved based on the ant colony algorithm, so as to realize quick parking space allocation of the unmanned vehicles.

In the present disclosure, the parking lot is a smart parking lot including a central server. And the to-be-parked vehicles sent a parking signal to the central server. The central server collects information of the to-be-parked vehicles, such as the sizes of the to-be-parked vehicles, positions of the to-be-parked vehicles, destinations of the to-be-parked vehicles, etc. Then the central server executes the parking space allocation method mentioned above and respectively sent allocation results to the to-be-parked vehicles. For instance, the central server may be a computer, and the parking space allocation method is executed by a processor installed in the computer, and the information of the to-be-parked vehicle may be stored in a memorier of the computer, which is not limited thereto.

Technical features of the above-mentioned embodiments can be combined arbitrarily. For the sake of brevity, all possible combinations of the technical features in the above-mentioned embodiments are not described. However, as long as there is no contradiction between the combinations of these technical features, the combinations should be considered to be within the scope of the specification.

The above-mentioned embodiments only represent some embodiments of the present disclosure. The descriptions thereof are specific and detailed, but should not be construed as a limitation of the scope of the present disclosure. It should be pointed out that for those of ordinary skill in the art, without departing from the concept of the present disclosure, modifications and improvements can be made. The modifications and the improvements belong to the protection scope of the present disclosure. Therefore, the protection scope of the present disclosure should be subject to the attached claims.

What is claimed is:

1. A parking space allocation method for vehicles having different driving modes, comprising:
respectively constructing single-vehicle cost models corresponding to driving modes of to-be-parked vehicles, and respectively constructing single-vehicle parking difficulty cost models based on sizes of the to-be-parked vehicles and parking space types;
respectively constructing user walking cost models and user psychological cost models based on the driving modes of the to-be-parked vehicles and psychological cost coefficients of users; respectively constructing parking space allocation cost models based on the driving modes of the to-be-parked vehicles, and constructing limiting conditions for the parking space allocation cost models to obtain parking allocation models;
performing cost balancing and allocating on the parking allocation models based on a minimum cost condition, and constructing optimization problems for the single-vehicle cost models, the single-vehicle parking difficulty cost models, the user walking cost models, the user psychological cost models, and the parking allocation models; and
solving the optimization problems to obtain parking space allocation schemes according to the tabu search algorithm and the ant colony algorithm.

2. The parking space allocation method according to claim 1, wherein the driving modes comprise a manned driving mode and an unmanned driving mode; a step of respectively constructing the single-vehicle cost models corresponding to the driving modes of the to-be-parked vehicles comprises:
constructing a first single-vehicle parking distance cost model when a to-be-parked vehicle i in the manned driving mode is allocated to a parking space j according to a parking distance thereof, and
constructing a second single-vehicle parking distance cost model or a first single-vehicle parking time cost model when a to-be-parked vehicle k in the unmanned driving mode is allocated to the parking space j according to a parking distance thereof and a parking time thereof.

3. The parking space allocation method according to claim 2, wherein an expression of the first single-vehicle parking distance cost model is:
$${r}_{i , j}^{D} = {\sum }_{s = 1}^{S} ( {a}_{s}^{drive} \frac{{l}_{s}}{{v}_{s}} + {a}_{s}^{b l o c k} {r}_{s}^{b l o c k} + {a}_{s}^{turn} {r}_{s}^{turn} ) ;$$
S is a total number of road sections that the to-be-parked vehicle i in the manned driving mode needs to pass to get to the parking space j; aₛ^{drive} a parking distance cost coefficient; 1ₛ is a mileage of an S^{th} road section; vₛ is an allowable speed of a parking lot; aₛ^{block} is a cost coefficient affected by parking of a vehicle ahead; rₛ^{block} is an additional cost affected by the parking of the vehicle ahead; a value of rₛ^{block} is a blocking time affected by the parking of the vehicle ahead; aₛ^{turn} is a cost coefficient affected by a curve on the S^{th} road section; rₛ^{turn} is an additional cost affected by the curve;
wherein an expression of the second single-vehicle parking distance cost model is:
$${r}_{k , j}^{D} = {\sum }_{s = 1}^{S} ( {a}_{s}^{drive} \frac{{l}_{s}}{{v}_{s}} + {a}_{s}^{b l o c k} {r}_{s}^{b l o c k} + {a}_{s}^{turn} {r}_{s}^{turn} ) ;$$
when the to-be-parked vehicle i in the manned driving mode or the to-be-parked vehicle k in the unmanned driving mode passes through the S^{th} road section; if there are parking vehicles on the S^{th} road section, the cost coefficient aₛ^{block} affected by the parking of the vehicle ahead is 1; and if there are no parking vehicles on the S^{th} road section, the cost coefficient aₛ^{block} affected by the parking of the vehicle ahead is 0.

4. The parking space allocation method according to claim 2, wherein an expression of the first single-vehicle parking time cost model is:
$${c}_{k , j}^{min D} = \frac{{t}_{k}^{a}}{n m} + ( {t}_{k , j}^{s} + {t}_{k , j}^{b} + {t}_{k , j}^{t} ) {x}_{k , j} ;$$
wherein k is a serial number of the to-be-parked vehicle k in the unmanned driving mode; the smaller a value of k; the earlier the to-be-parked vehicle k arrives at a parking lot; n is a total number of to-be-parked vehicles in the unmanned driving mode, m is a total number of available parking spaces in the parking lot; tₖ^{a} is a time cost for the to-be-parked vehicle k in the unmanned driving mode to arrive at a parking lot; t_{k,j}^{s} is a driving time cost converted from a distance from the to-be-parked vehicle k in the unmanned driving mode to the parking space j; t_{k,j}^{b} is a blocking waiting time cost from the to-be-parked vehicle k in the unmanned driving mode to the parking space j; t_{k,j}^{t} is an additional time cost affected by the curve from the to-be-parked vehicle k in the unmanned driving mode to the parking space j; x_{k,j}={0, 1} is a Boolean variable; when x_{k,j}^{t}=0, the to-be-parked vehicle k in the unmanned driving mode is not allocated to the parking space j; when x_{k,j}=1, the to-be-parked vehicle k in the unmanned driving mode is allocated to the parking space j.

5. The parking space allocation method according to claim 2, wherein a step of respectively constructing the single-vehicle parking difficulty cost models based on sizes of the to-be-parked vehicles and parking space types comprises:
respectively constructing a first single-vehicle parking difficulty cost model and a second single-vehicle parking difficulty cost model according to the sizes of the to-be-parked vehicles and the parking space types;
wherein an expression of the first single-vehicle parking difficulty cost model is
r_{i,j}^{P}=(a_{i,j}^{len}+aⱼ^{lot})rₚ
r_{k,j}^{P}=(a_{k,j}^{len}+aⱼ^{lot})rₚ
a_{i,j}^{len} is a cost coefficient affected by a length of the to-be-parked vehicle i in the manned driving mode; aⱼ^{lot} is a cost coefficient affected by a parking characteristics of the parking space j; rₚ is a conventional parking cost; a_{k,j}^{len} is a cost coefficient affected by the to-be-parked vehicle k in the unmanned driving mode; a calculation formula of the cost coefficient a_{i,j}^{len} affected by the length of the to-be-parked vehicle i in the manned driving mode is:
$${a}_{i , j}^{l e n} = \frac{{l}_{i}^{c a r}}{{l}_{j}^{l o t}} ;$$
lᵢ^{car} is the length of the to-be-parked vehicle i in the manned driving mode; lⱼ^{lot} is a length of the parking space j; a calculation formula of the cost coefficient a_{i,j}^{len} affected by the to-be-parked vehicle k in the unmanned driving mode is:
$${a}_{k , j}^{l e n} = \frac{{l}_{k}^{c a r}}{{l}_{j}^{l o t}} ;$$
lᵢ^{car} is a length of the to-be-parked vehicle k in the unmanned driving mode;
wherein an expression of the second vehicle parking difficulty cost model is:
c_{k,j}^{minP}=(a_{k,j}^{len}+aⱼ^{lot})tₚx_{k,j};
wherein Tₚ is a conventional parking cost.

6. The parking space allocation method according to claim 2, wherein in a step of respectively constructing user walking cost models and user psychological cost models based on the driving modes of the to-be-parked vehicles and psychological cost coefficients of users, an expression of a user walking cost model for the to-be-parked vehicle i in the manned driving mode is:
r_{i,j}^{W}=aᵢ^{lot}r_{i,j}^{lot}+aᵢ^{road}rᵢ^{road};
wherein aᵢ^{lot} is a walking cost coefficient for a user of the to-be-parked vehicle i in the manned driving mode to walk out a parking lot; r_{i,j}^{lot} is a walking cost for the user of the to-be-parked vehicle i in the manned driving mode to walk out the parking lot from the parking space j; a value of the walking cost for the user of the to-be-parked vehicle i in the manned driving mode to walk out the parking lot from the parking space j is a walking time of the user of the to-be-parked vehicle i in the manned driving mode to walk out the parking lot from the parking space j; aᵢ^{road} is a walking cost coefficient for the user of the to-be-parked vehicle i in the manned driving mode to walk to a destination from an outside of the parking lot; rᵢ^{road} is a walking cost for the user of the to-be-parked vehicle i in the manned driving mode to walk to the destination from the outside of the parking lot; the walking cost for the user of the to-be-parked vehicle i in the manned driving mode to walk to the destination from the outside of the parking lot is a walking time for the user of the to-be-parked vehicle i in the manned driving mode to walk to the destination from the outside of the parking lot;
wherein an expression of a user psychological cost model of the user psychological cost models is:
r_{i,j}^{H}=a_{i,j}^{lot}aᵢ^{lot}r_{i,j}^{lot}+aᵢ^{road}aᵢ^{road}rᵢ^{road};
a_{i,j}^{lot} is a psychological cost coefficient for the user of the to-be-parked vehicle i in the manned driving mode to walk out of the parking lot from the parking space j; aᵢ^{road} is a psychological cost coefficient for the user of the to-be-parked vehicle i in the manned driving mode to walk to the destination from the outside of the parking lot;
wherein an expression of the psychological cost coefficient a_{i,j}^{lot} for the user of the to-be-parked vehicle i in the manned driving mode to leave the parking lot from the parking space j is:
$${a}_{i , j}^{lot} = {a}_{lot} tanh ( \frac{{r}_{i , j}^{l o t}}{{r}_{max}^{l o t}} ) .$$
aₗₒₜ≥1.0; aₗₒₜ is an adjustment coefficient; rₘₐₓ^{lot} at is a maximum walking cost acceptable to the user of the to-be-parked vehicle i in the manned driving mode for walking out of the parking lot from the parking space j;
wherein an expression of the psychological cost coefficient for the user of the to-be-parked vehicle i in the manned driving mode to walk to the destination from the outside of the parking lot is:
$${a}_{i , j}^{road} = {a}_{road} tanh ( \frac{{r}_{i , j}^{r o a d}}{{r}_{max}^{r o a d}} ) ;$$
a_{road}≥1.0; a_{road} is an adjustment coefficient; rₘₐₓ^{road} is a maximum walking cost acceptable to the user of the to-be-parked vehicle i in the manned driving mode for walking to the destination from the outside of the parking lot.

7. The parking space allocation method according to claim 2, wherein an expression of the parking space allocation cost models is:
Rⱼ=Σᵢ₌₁^{I}r_{i,j}x_{i,j}+Σₖ₌₁^{K}r_{k,j}x_{k,j};
wherein r_{i,j} is a single-vehicle parking space allocation cost of the to-be-parked vehicle i in the manned driving mode; r_{k,j} is a single-vehicle parking space allocation cost of the to-be-parked vehicle k in the unmanned driving mode; I is a total number of the to-be-parked vehicles in the manned driving mode; K is a total number of the to-be-parked vehicle kin the unmanned driving mode; x_{i,j}={0, 1}; x_{i,j} is a binary variable; when x_{i,j}=0, the paring space j is not allocated to the to-be-parked vehicle i in the manned driving mode; when x_{i,j}=1, the parking space j is allocated to the to-be-parked vehicle i in the manned driving mode; xₖ={0, 1}; xₖ is a binary variable; when xₖ,=0, the parking space j is not allocated to the to-be-parked vehicle k in the unmanned driving mode; when xₖ,=1, the parking space j is allocated to the to-be-parked vehicle k in the unmanned driving mode;
wherein for the parking space j allocated to the to-be-parked vehicle i in the manned driving mode, an expression of a single-vehicle parking space allocation cost model thereof is:
r_{i,j}=r_{i,j}^{D}+r_{i,j}^{P}+r_{i,j}^{W}+r_{i,j}^{H},
wherein for the parking space j allocated to the to-be-parked vehicle k in the unmanned driving mode, an expression of a single-vehicle parking space allocation cost model thereof is:
r_{k,j}=r_{k,j}^{D}+r_{k,j}^{P}+r_{k,j}^{W}+r_{k,j}^{H}.

8. The parking space allocation method according to claim 2, wherein in a step of performing cost balancing and allocating on the parking allocation models based on the minimum cost condition, when the parking space j is allocated to the to-be-parked vehicle k in the unmanned driving mode, an expression of a single-vehicle parking space allocation cost model having a minimum cost is:
c_{k,j}^{min}=c_{k,j}^{minD}+c_{k,j}^{minP};
wherein for the to-be-parked vehicle k in the unmanned driving mode, an expression of a single-vehicle parking space allocation total cost model having the minimum cost is:
cₖ^{min}=Σₕ₌₁^{m}c_{k,j}^{min}=Σₕ₌₁^{m}(c_{k,j}^{minD}+c_{k,j}^{minP});
wherein a parking space allocation total cost model having a minimum cost is obtained base on the single-vehicle parking space allocation cost model having the minimum cost and the single-vehicle parking space allocation total cost model having the minimum cost, an expression thereof is:
c^{min}=Σₖ₌₁ⁿcₖ^{min}=Σₖ₌₁ⁿΣⱼ₌₁^{m}c_{k,j}^{min}=Σₖ₌₁ⁿΣⱼ₌₁^{m}(c_{k,j}^{minD}+c_{k,j}^{minP}).

9. The parking space allocation method according to claim 8, wherein before a step of solving the optimization problems to obtain the parking space allocation schemes according to the tabu search algorithm and the ant colony algorithm, the parking space allocation method further comprises:
respectively constructing a first-come-first-served single-vehicle driving cost model, a first-come-first-served single-vehicle parking difficulty cost model, a first-come-first-served single-vehicle parking space allocation cost model, and a first-come-first-served single-vehicle parking space allocation total cost model based on a first-come-first-served allocation rule; and
constructing a first-come-first-served allocation optimization problem based on the first-come-first-served single-vehicle driving cost model, the first-come-first-served single-vehicle parking difficulty cost model, the first-come-first-served single-vehicle parking space allocation cost model, and the first-come-first-served single-vehicle parking space allocation total cost model.

10. The parking space allocation method according to claim 9, wherein the step of solving the optimization problems to obtain the parking space allocation schemes according to the tabu search algorithm and the ant colony algorithm comprises:
solving the optimization problems and the first-come-first-served allocation optimization problem according to the tabu search algorithm and the ant colony algorithm; using an obtained optimal solution as a reference value of the parking space allocation scheme to construct the parking space allocation scheme.
